(19) United States
(12) Patent Application Publication
(10) Pub. No.: US 2009/0266748 A1
(43) Pub. Date: Oct. 29, 2009

(54) POPCORN SIEVE

(76) Inventor: Deborah A. Boris, Rossford, OH (US)

Correspondence Address: FRASER CLEMENS MARTIN & MILLER LLC, 28366 KENSINGTON LANE, PERRYSBURG, OH, 43551, US

(21) Appl. No.: 12/429,275

(22) Filed: Apr. 24, 2009

Related U.S. Application Data
(60) Provisional application No. 61/048,744, filed on Apr. 29, 2008.

(51) Int. Cl. B07B 1/04

(52) U.S. Cl. 209/352

(57) ABSTRACT

A sieve for separating popped corn from un-popped kernels of corn is disclosed. The sieve includes a plate having a first surface, a spaced apart second surface, and a peripheral edge. A plurality of holes is formed in the plate. An engaging member is provided to facilitate grasping the plate. The sieve includes a plurality of legs depending from the second surface of the plate. The sieve is adapted to be received in an associated receptacle and form a chamber at the bottom of the receptacle, wherein un-popped kernels of corn pass through the holes formed in the plate and are received in the chamber to substantially separate popped corn from un-popped kernels of corn.

### CROSS-REFERENCE TO RELATED APPLICATION

This application claims the benefit of U.S. Provisional Patent Application Ser. No. 61/048,744 filed on Apr. 29, 2008, hereby incorporated herein by reference in its entirety.

### FIELD OF THE INVENTION

The invention relates to a popcorn sieve, and more specifically to a popcorn sieve adapted to cooperate with a receptacle to separate popped corn from un-popped kernels of corn.

### BACKGROUND OF THE INVENTION

Popcorn is a popular snack food that is enjoyed by many individuals. Popcorn is often eaten plain or is eaten after a topping is added to the popcorn such as butter, caramel, or chocolate, for example. However, the popped corn typically includes un-popped kernels of corn mixed therewith.

The un-popped corn kernels can interfere with the eating or use of the popped corn. For example, if the individual eating the popped corn introduces an un-popped kernel into her mouth and bites down on the kernel, a tooth of the user can be damaged. Additionally, if the popped corn is used as an ingredient in a prepared food such as caramel corn or chocolate covered popcorn, for example, the un-popped kernels may be included in the prepared food.

It would be desirable to have a popcorn sieve adapted to cooperate with a receptacle to facilitate the separation of popped corn from un-popped kernels of corn.

### SUMMARY OF THE INVENTION

Compatible and attuned with the present invention, a popcorn sieve adapted to cooperate with a receptacle to facilitate the separation of popped corn from un-popped kernels of corn, has surprisingly been discovered.

The above objective, as well as others, may be achieved by a popcorn sieve comprising a plate having an upper surface, a spaced apart lower surface, and a peripheral edge, the plate including a plurality of holes formed therein; means for facilitating the grasping of the plate; and a plurality of legs depending from the lower surface of the plate.

The above objective may also be achieved by a kit for use with a variety of associated receptacles to facilitate the separation of popped corn from un-popped kernels of corn comprising a plurality of popcorn sieves, each sieve including a plate having an upper surface, a spaced apart lower surface, and a peripheral edge, the plate including a plurality of holes formed therein, means for facilitating the grasping of the plate, and a plurality of legs depending from the lower surface of the plate, wherein each sieve is adapted to cooperate with differently sized receptacles.

### BRIEF DESCRIPTION OF THE DRAWINGS

The above, as well as other objects and advantages of the invention, will become readily apparent to those skilled in the art from the following detailed description of an embodiment of the invention when considered in the light of the accompanying figures, in which:

FIG. 1 is a top perspective view of a popcorn sieve according to an embodiment of the invention;

FIG. 2 is a bottom plan view of the popcorn sieve illustrated in FIG. 1;

FIG. 3 is a side elevational view of the popcorn sieve illustrated in FIGS. 1 and 2; and

FIG. 4 is a cross-sectional side-elevational view of the popcorn sieve illustrated in FIG. 1 received within an associated receptacle showing popped corn disposed on an upper surface of the sieve and un-popped kernels of corn that have been separated from the popped corn at a bottom inner surface of the receptacle.

### DETAILED DESCRIPTION OF AN EMBODIMENT OF THE INVENTION

The following detailed description and appended photos describe and illustrate various exemplary embodiments of the invention. The description and photos serve to enable one skilled in the art to make and use the invention, and are not intended to limit the scope of the invention in any manner.

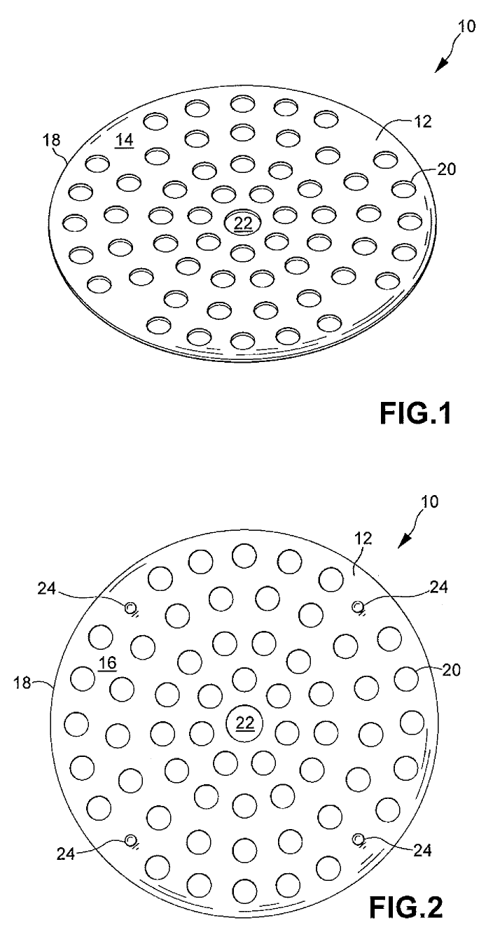

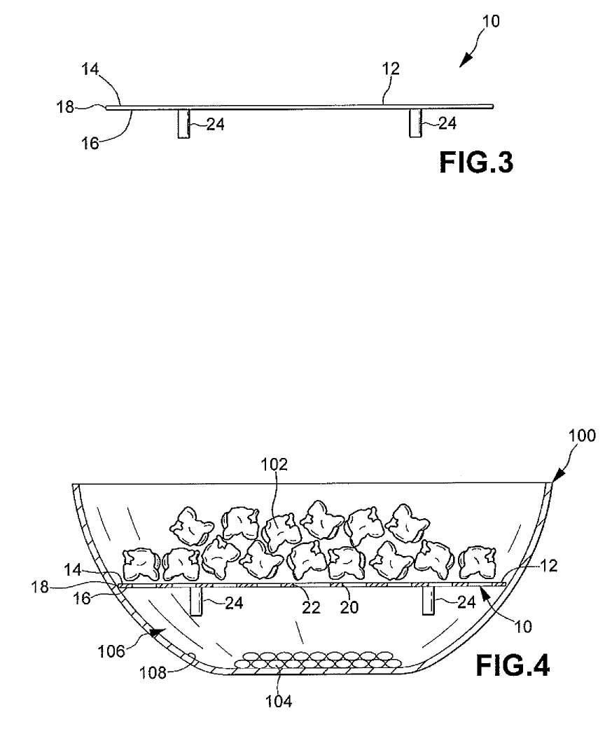

Referring to FIGS. 1-3 there is illustrated a popcorn sieve 10. As shown in FIG. 4, the sieve 10 is adapted to cooperate with an associated receptacle 100 to facilitate the separation of popped corn 102 from un-popped kernels of corn 104. The popcorn sieve 10 includes a plate 12 having a first surface 14, a spaced apart second surface 16, and a peripheral edge 18. The plate 12 includes a plurality of holes 20 formed therein.

The illustrated sieve 10 is generally disk shaped having a selected diameter. Favorable results have been obtained employing diameters of about 5½ inches, 7 inches, and 9 inches for the sieve 10. It should be understood that the sieve 10 can have other shapes and sizes as desired to facilitate the cooperation of the sieve 10 with receptacles having various shapes and sizes. Sieves having different diameters or shapes may be formed in different colors or provided with a selected distinguishing mark, for example, to facilitate a user identifying the different sieves.

Favorable results have been obtained employing holes 20 having a diameter of about 13/32 inches. However, it should be understood that holes 20 having other diameters may be used as desired. In the illustrated embodiment, the holes 20 have a generally circular shape. It should be understood that the holes can have other shapes such as ovals, squares, triangles, or stars, for example.

As shown, the sieve 10 is formed from a plastic material such as polycarbonate employing an injection molding process. However, it should be understood that the sieve 10 can be formed employing other materials such as wood, metal, porcelain, or other materials having suitable physical properties, and other processes such as a stamping process or a compression molding process, for example.

The sieve 10 includes a user engaging member to facilitate a user grasping the sieve 10. In the illustrated embodiment the user engaging member is a grasping hole 22 formed in the plate 12 substantial at a center thereof. Favorable results have been obtained employing a diameter of about 21/32 inches for the grasping hole 22 to facilitate the user inserting a finger therethrough to grasp the sieve 10. It should be understood that the grasping hole 22 may have other diameters and shapes as desired. Additionally, the grasping hole 22 may be formed at locations in the plate 12 other than the center. Further, it should be understood that the user engaging member for the sieve 10 can be a knob, a handle, and the like disposed on the first surface 14 of the plate 12, or a cut-out-hole at the peripheral edge 18 of the plate 12.

A leg 24 depends from the second surface 16 of the plate 12. As shown, the leg 24 is an elongate generally cylindrically shaped leg. However, it should be understood that the leg 24 can be one or more protrusions, one or more walls, an annular ring, or any other suitable member or members depending from the second surface 16. Favorable results have been obtained employing four legs 24 substantially evenly spaced and adjacent the peripheral edge 18 of the plate 12, wherein the legs are about 0.75 an inch long. It should be understood that other quantities of legs 24 can be used. Additionally, it should be understood that other lengths of the legs 24 can be used.

A gripping member (not shown) can be disposed on or adjacent the peripheral edge 18 of the plate 12 to facilitate maintaining the sieve 10 within the receptacle. It should be understood that the gripping member can be a continuous member circumscribing the plate 10, or include an annular array of gripping members disposed around the peripheral edge 18. Additionally, a gripping member can be provided for ends of the legs 24 to minimize a movement of the sieve 10 in respect of a supporting surface such as the bottom of the receptacle 100.

As shown in FIG. 4, the sieve 10 is adapted to be placed in the receptacle 100 to form a chamber 106 between the sieve 10 and an inner 108 of the receptacle 100. In the illustrated embodiment the receptacle 100 is a bowl, wherein the sieve 10 is supported by an inner surface of the bowl in contact with the peripheral edge 18 of the plate 12. It should be understood that the sieve 10 can be received in another type of receptacle such as a pan, wherein the legs 24 contact a bottom surface of the receptacle 100 to form the chamber 106 between the sieve 10 and the inner surface 108 of the receptacle 100.

In use, the sieve 10 is placed in the receptacle 100 to form the chamber 106 between the sieve 10 and the inner surface 108 of the receptacle 100. A quantity of popped corn 102, which will typically include a number of un-popped kernels of corn 104, is poured into the receptacle 100 onto the first surface 14 of the plate 12. The receptacle 100 is shaken with the sieve 10 and the popped corn 102 disposed therein. It should be understood that a lid can be used to cover the receptacle 100 during the shaking thereof to militate against spillage of the popped corn 102. The holes 20 formed in the plate allow the un-popped kernels of corn 104 to pass therethrough and be received in the chamber 106 while maintaining the popped corn 102 on top of the plate 12. The un-popped kernels of corn 104 are caused to be separated from the popped corn 102 after shaking the receptacle 100. The popped corn 102 is removed from the receptacle 100 and can be eaten or used for preparing other foods, for example, without an interference from the un-popped kernels of corn 104. Once the popped corn 102 is removed, a user can insert a finger into the grasping hole 22 to remove the sieve 10 from the receptacle 100 and discard the un-popped kernels of corn 104.

The sieve 10 is economical, easy to use, can be sold individually or as a set or kit of selectively sized sieves, and is adapted to facilitate separating popped corn 102 from un-popped kernels of corn 104. By removing the un-popped kernels of corn 104 from the popped corn 102, the likelihood that un-popped kernels of corn 104 will be introduced into the mouth of a person eating the popped corn 102 is minimized. The sieve 10 can be sold individually or as a set together with one or more receptacles 100.

The sieve 10 can also be used for steaming items such as vegetables in a microwave oven or on a stove top, for example. Water is disposed in the chamber 106 formed between the sieve 10 and the inner surface 108 of the receptacle 100, and the item to be steamed is disposed onto the first surface 14 of the plate 12. Heat energy is applied to the water to produce steam. The steam passes through the holes 20 and contacts the items being steamed. It should be understood that the material employed to form the sieve 10 can be selected to have suitable heat resistant properties.

The sieve 10 can also be employed to separate liquids from solid foods. For example, juices associated with cut fruit can be drained from the fruit by placing the sieve 10 in the receptacle 100 (such as a serving bowl) and placing the cut fruit on the first surface 14 of the plate 12, wherein the juices drain into the chamber 106.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A sieve comprising:
a plate having a first surface, a spaced apart second surface, and a peripheral edge, the plate including a plurality of holes formed therein and an engaging member to facilitate grasping the plate; and
a leg depending from the second surface of the plate.

2. The sieve according to claim 1, wherein the sieve is formed of a plastic material.

3. The sieve according to claim 2, wherein the plastic material is polycarbonate.

4. The sieve according to claim 1, wherein the plate is generally disk shaped.

5. The sieve according to claim 1, wherein the engaging member is a hole formed in the plate.

6. The sieve according to claim 5, wherein the hole forming the engaging member is larger than the plurality of holes formed in the plate.

7. The sieve according to claim 1, wherein the engaging member is formed adjacent a center of the plate.

8. The sieve according to claim 1, wherein the legs are disposed adjacent the peripheral edge of the plate.

9. The sieve according to claim 1, wherein the legs are about 0.75 inches long.

10. A kit to facilitate the separation of differently sized items comprising:
a plurality of sieves, each of the sieves having a plate including a first surface, a spaced apart second surface, and a peripheral edge, the plate including a plurality of holes formed therein, an engaging member to facilitate grasping the plate, and a plurality of legs depending from the second surface thereof, wherein the sieves are adapted to cooperate with differently sized receptacles.

11. The kit according to claim 10, including at least one receptacle to facilitate the separation of differently sized items.

12. A method for separating a mixture of differently sized items, the method comprising the steps of:
providing a receptacle having an inner surface;
providing a sieve, the sieve having a plate including a first surface, a spaced apart second surface, and a peripheral edge, the plate including a plurality of holes formed therein, an engaging member to facilitate grasping the plate, and a plurality of legs depending from the second surface of the plate;
placing the sieve within the receptacle to form a chamber between the sieve and the inner surface of the receptacle;
placing the items to be separated on the first surface of the plate; and
causing at least some of the items to pass through the holes formed in the plate and be received in the chamber.

13. The method of claim 12, wherein the step of causing items to pass through the holes formed in the plate includes shaking the receptacle.
